(19) United States
(12) Patent Application Publication
(10) Pub. No.: US 2026/0307784 A1
(43) Pub. Date: Oct. 8, 2026

(54) METHOD AND DEVICE FOR ASSISTING THE PILOTING OF AN AIRCRAFT COMPRISING A HYBRID POWER PLANT FOR INDICATING BY HAPTIC FEEDBACK AN AMOUNT OF ELECTRICAL ENERGY OF AN ELECTRICAL ENERGY SOURCE

(71) Applicant: AIRBUS HELICOPTERS, Marignane Cedex (FR)

(72) Inventors: Romain BARTHELEMY, Marignane Cedex (FR); Jean-François LOGEAIS, Marignane Cedex (FR); Marc GAZZINO, Marignane Cedex (FR); Romain KOVEL, Marignane Cedex (FR); Romain NEVERS, Marignane Cedex (FR); Mounir AMOKRANE, Marignane Cedex (FR)

(73) Assignee: AIRBUS HELICOPTERS, Marignane Cedex (FR)

(21) Appl. No.: 19/392,942

(22) Filed: Nov. 18, 2025

(30) Foreign Application Priority Data
Apr. 2, 2025 (FR) FR2503451

(51) Int. Cl. B64C 13/50; B64C 13/04; B64C 13/10; B64D 27/33; B64D 27/355; B64F 5/60

(52) U.S. Cl. CPC B64C 13/50; B64C 13/042; B64C 13/10; B64D 27/33; B64D 27/355; B64F 5/60

(57) ABSTRACT

A method for assisting piloting of an aircraft, the aircraft comprising a hybrid power plant as well as a drive train controlling an aerodynamic control surface and provided with a flight control and a control actuator connected to the control. According to this method, at least one characteristic of the hybrid power plant is measured, then a threshold relating to a functional parameter of the hybrid power plant is determined as a function of the characteristic. A limit position of the control is then calculated for which the functional parameter is equal to the threshold, a current position of the control is measured, and a first force is applied to the control according to a predetermined force law as a function of an amount of electrical energy of an electrical energy source of the hybrid power plant when the current position exceeds the limit position.

### CROSS REFERENCE TO RELATED APPLICATION

This application claims priority to FR 25 03451 filed on Apr. 2, 2025, the disclosure of which is incorporated in its entirety by reference herein.

### TECHNICAL FIELD

The present disclosure relates to the technical field of aircraft flight controls, and in particular for aircraft provided with a hybrid power plant.

### BACKGROUND

The disclosure relates to a method for assisting the piloting of an aircraft provided with a hybrid power plant and to a device for assisting the piloting of such an aircraft, in order to indicate, by haptic feedback, an amount of electrical energy of an electrical energy source of the hybrid power plant.

An aircraft, and in particular a rotorcraft, may comprise one or more rotors driven in rotation by a power plant. A rotorcraft may, for example, comprise a lift rotor participating in lifting or even moving the rotorcraft. A rotorcraft may also comprise an auxiliary rotor, for example a tail rotor, in order in particular to control the yaw movements of the rotorcraft. A rotorcraft may also comprise one or more propellers.

Hereinafter, the term "rotor" may refer, in particular, to a lift rotor, an auxiliary anti-torque rotor for controlling the yaw movements of the rotorcraft or a pusher or tractor propeller.

An aircraft also comprises at least one aerodynamic control surface controlled using a flight actuator, for example a servo-control, in order to steer the aircraft. An aerodynamic control surface may be a blade of a rotor. An aerodynamic control surface may also be an aileron or rudder flap for example arranged on a wing or a tail unit, an angle of inclination of which is modified by a flight actuator.

In addition, a drive train comprises a flight control, such as a lever, stick or rudder bar for example, manipulated by a pilot to control an aerodynamic control surface, via at least one flight actuator.

The flight control system may be said to be "electrical", with the flight control transmitting an electrical or optical signal in order to control a flight actuator. The flight control system may be said to be "mechanical", with the flight control being connected by a plurality of connecting rods to the flight actuator in order to control it.

Document FR 2946620 describes a control actuator connected directly to a flight control and configured to anchor the flight control at a predefined position, in particular during operation of an autopilot system of the aircraft. Such a control actuator can also act as a soft or hard stops.

In the context of a mechanical flight control, this control actuator is referred to as a "parallel actuator" or "trim actuator", and directly connects the flight control or a connecting rod of the drive train to a fixed point of the structure of the aircraft. This parallel actuator is one of the components of an aircraft autopilot system.

The power plant of such an aircraft may be a hybrid power plant. A hybrid power plant may comprise at least one heat engine and at least one electric machine, as well as a mechanical transmission system driving the rotation of one or more rotors using said at least one heat engine and/or said at least one electric machine.

Such a hybrid power plant also comprises a source of electrical energy, electrically powering the electric machine or machines, via an electrical system. Hereinafter, the term "source" is used to more simply refer to a source of electrical energy.

This source may comprise, for example, at least one rechargeable electric battery, a fuel cell connected to a fuel tank, and/or a supercapacitor.

The electric machine may be an electric motor having only a motor function for transforming electrical energy supplied by the source into mechanical energy transmitted to the mechanical transmission system and then to the rotor. Alternatively, the electric machine may be an electrical generator having only a generator function for transforming mechanical energy transmitted by the mechanical transmission system into electrical energy for, for example, recharging the source or electrically powering the equipment of the aircraft. The electric machine may also be a motor-generator having the motor function and the generator function.

It should be noted that the expression "heat engine" designates for convenience throughout the text any heat engine, for example turboshaft engines or piston engines. The expression "heat engine" is used in contrast to the terms "electric motor" or "electric machine" that describe motors driven by electrical energy.

Depending on the operation of the hybrid power plant, the one or more heat engines and the one or more electric machines may be installed differently, and may be used independently or in combination, simultaneously or sequentially, for driving the rotation of a rotor.

However, the use of such an electric machine is subject to certain constraints, in particular related to the source of electrical energy. Indeed, the low energy density of electric batteries compared to that of the fuel supplying the heat engines is a constraint to be taken into account in the sizing of the hybrid power plant, as well as in its mode of use. The current amount of electrical energy of the source that can be supplied to an electric machine in flight is therefore limited, and so allows the supply of electrical power for a limited duration. Moreover, an electrical energy source may be rechargeable and as such may be recharged, at least partially, in flight, its current amount of electrical energy thus increasing.

Consequently, the amount of electrical energy of the source can vary considerably during a flight. However, the pilot needs to be constantly aware of the amount of electrical energy in the source, in order to determine the performance attainable by the aircraft. An indicator can indicate this amount of electrical energy of the source to the pilot, as well as optionally the electrical energy consumed by the hybrid power plant. However, a pilot may have a significant workload, preventing him from constantly consulting this indicator.

Document US 10193374 is far from the technical field of the disclosure. This document describes an electronic device provided with an electric battery, such as a smartphone, a laptop, a tablet or a watch. If necessary, this electronic device indicates, for example by the generation of one or more vibrations, that the amount of electrical energy of the battery has fallen below a predetermined threshold.

The technological background of the disclosure also includes documents US2005/0151672, FR3117447 and FR3021627.

### SUMMARY

One object of the disclosure is therefore to provide a device and a method for assisting piloting of an aircraft that make it possible to overcome the limitations mentioned above, and aim to reduce the workload of the pilot of the aircraft.

An object of the present disclosure is, first of all, to propose a method for assisting the piloting of an aircraft, said aircraft comprising at least one drive train for controlling an aerodynamic control surface, the drive train being provided with a flight control and with a control actuator connected to the flight control, this aircraft comprising a hybrid power plant, said hybrid power plant being provided with at least one heat engine, at least one electric machine, a source of electrical energy and a mechanical transmission system driving the rotation of a rotor.

According to the disclosure, such a method for assisting the piloting of an aircraft comprises the following steps:

measuring at least one characteristic of said at least one heat engine, mechanical transmission system or rotor;

determining a threshold relating to a functional parameter of the hybrid power plant as a function of said at least one characteristic;

calculating a limit position of the flight control for which the functional parameter of the hybrid power plant is equal to the threshold;

measuring a current position of the flight control; and

applying a first force to the flight control using the control actuator according to a predetermined force law when the current position of the flight control exceeds the limit position, the predetermined force law being a function at least of a current amount of electrical energy of the source.

The present disclosure thus consists in returning to the pilot of the aircraft, substantially in real time, a force feedback through the flight control, that is a function of the current amount of electrical energy of the source. In this way, the pilot is aware of the amount of energy available at the source without the need to look at a display, and remains advantageously focused on the outside of the aircraft and on the maneuver to be carried out.

A computer of the aircraft, optionally dedicated to carrying out the method according to the disclosure, is configured to receive the measurement of one or more characteristics related to the operation of said at least one heat engine, the mechanical transmission system or the rotor, and then to determine a threshold relating to a functional parameter of the hybrid power plant and a limit position of the flight control corresponding to this threshold. The threshold and the limit position of the flight control may be determined using laws previously recorded in a memory of the computer or in a memory connected to the computer.

The computer then controls the control actuator to generate a first resistive force on the flight control when the limit position is exceeded. The first force varies as a function, in particular, of the current amount of electrical energy of the source so that the pilot of the aircraft is aware, using the flight control and through this first force, of this current amount of electrical energy of the source.

When the flight control returns below the limit position, the generation of the first force is stopped.

The method according to the disclosure may be applied to any flight control of the aircraft, controlling the position of an aerodynamic control surface exerting an influence on the movement of the aircraft, and, for example, on the blades of a rotor or an aileron or rudder flap. This method may, in particular, be applied to the flight control controlling the propulsive power of the aircraft. In the particular case of a conventional helicopter, the method can thus be applied to the stick controlling a collective variation in the pitch of the blades of the lift rotor.

The control actuator may be dedicated to performing the method according to the disclosure. Alternatively, the control actuator may perform other functions, and may optionally take the form of a trim actuator. The control actuator may be a hydraulic, pneumatic or electric cylinder, or an electric motor.

The method according to the disclosure may also comprise one or more of the following features, taken individually or in combination.

According to one possibility, the current position and the limit position of the flight control may be defined respectively by angles of the flight control with respect to a reference position of the flight control.

The reference position of the flight control is, for example, a neutral position of the flight control reached when no force is applied to this flight control by a pilot.

According to one possibility compatible with the preceding possibilities, said at least one characteristic may comprise one or more of the following characteristics:

an internal temperature, an engine torque, a maximum engine torque and an aging rate of said at least one heat engine, a duration of use of this heat engine at this engine torque;

an internal temperature, an engine torque, a maximum engine torque and an aging rate of the mechanical transmission system; and

a speed of rotation of the rotor.

The one or more characteristics thus enable the operation of said at least one heat engine, said power transmission gearbox and/or the rotor to be characterized. One or more of these characteristics can thus be used to determine the threshold of the functional parameter of the hybrid power plant.

The ageing rate of said at least one heat engine or of said power transmission gearbox is, for example, equal to a duration of operation, or is determined as a function of at least this duration of operation.

According to one possibility compatible with the preceding possibilities, the method may comprise measuring at least one environmental parameter from among a temperature and an atmospheric pressure outside the aircraft; determining the threshold and calculating the limit position of the flight control being able to be carried out as a function of said at least one environmental parameter.

According to one possibility compatible with the preceding possibilities, the calculation of a limit position may be carried out as a function of the threshold, the functional parameter of the hybrid power plant, a forward speed of the aircraft and a speed of rotation of the rotor.

In this case, the method comprises measuring the forward speed of the aircraft and the speed of rotation of the rotor. These measurements can be made by sensors dedicated to the process or forming part of an avionics system of the aircraft that transfers these measurements to the computer responsible for implementing the method.

According to one possibility compatible with the preceding possibilities, the predetermined force law may be selected from a list comprising, for example:

a stepwise law, the steps being associated respectively with intervals of the amount of electrical energy of the source, the first force being constant for each step and increasing from one step to the next in parallel with a decrease in the amount of electrical energy of the source;

an elastic law, the first force varying with the current position of the flight control, and the amount of electrical energy of the source, the first force being equal to a current angle of the flight control multiplied by a first stiffness, the first stiffness increasing as a function of a decrease in the amount of electrical energy of the source, continuously or in steps, the current angle of the flight control being defined with respect to a reference position of the flight control;

a damping law, the first force varying with a speed of movement of the flight control and the amount of electrical energy of the source, the first force being equal to this speed of movement multiplied by a second stiffness, the second stiffness increasing as a function of a decrease in the amount of electrical energy of the source, continuously or in steps; and

a vibratory law, the first force generating vibrations in the flight control at each passing of predetermined levels of electrical energy of the source, an intensity of the vibrations being identical at each passing or gradually increasing from one passing to another as the amount of electrical energy of the source decreases.

In this way, the pilot, knowing the predetermined force law applied to generate the first force, can be aware, by haptic feedback, of the current amount of electrical energy of the source.

These laws may have been recorded in a memory of the computer or in a memory connected to the computer.

According to one possibility compatible with the preceding possibilities, the method may comprise the electric machine supplying non-zero mechanical power to the rotor when the current position of the flight control is greater than or equal to the limit position.

In this way, as soon as the current position of the flight control reaches the limit position, i.e., as soon as the functional parameter of the power plant is substantially equal to the threshold, the electric machine is controlled to supply non-zero mechanical power to the rotor, via the mechanical transmission system, in order to inject this mechanical power into the propulsion system, and thus contribute, alone or in combination with the one or more heat engines of the power plant, to driving the rotation of this rotor. For this purpose, the computer may control the electric machine directly, or via a controller associated with the electric machine.

The electric machine can thus be started automatically when the current position of the flight control reaches the limit position in order to supply the non-zero mechanical power to the rotor. This start-up may additionally be signaled by displaying a piece of information on a screen of the aircraft cockpit.

Alternatively, the electric machine may be started beforehand, while supplying zero mechanical power as long as the current position of the flight control is below the limit position.

Thus, when the threshold is reached by the functional parameter, the electric machine automatically supplies additional power to the rotor so as, for example, to prevent the functional parameter from exceeding the threshold, or from exceeding it too much, advantageously preserving the one or more heat engines and the mechanical transmission system.

When the flight control returns below the limit position, the electric machine is stopped, or alternatively remains started without supplying mechanical power to the rotor.

According to one possibility compatible with the preceding possibilities, the functional parameter may be an engine torque of said at least one heat engine, and the threshold may be a predetermined limit torque of said at least one heat engine.

This limit torque corresponds, for example, to a torque saturation of the heat engine, i.e., the heat engine reaches an operating limit that may possibly generate damage in the event of exceeding the limit, in particular if this exceeding of the limit lasts, for example, for several minutes. This limit torque is, in particular, a function of the temperature and of the atmospheric pressure outside the aircraft. This limit torque may also be a function of the ageing rate of this heat engine.

The limit torque may, according to another example, be a torque reached when the heat engine is operating at a special speed. Such a special speed may allow the heat engine to supply high power and high engine torque, and in particular higher than a nominal power and torque for a limited duration, for example a duration equal to 30 seconds or five minutes. Beyond this limited duration, degradation of the heat engine or the power transmission system is possible.

In this way, as soon as the current position of the flight control reaches the limit position, i.e., as soon as the functional parameter relating to the operation of the heat engine is substantially equal to the threshold, the electric machine is controlled to supply non-zero mechanical power to the rotor, via the mechanical transmission system.

Alternatively, the functional parameter may be an engine torque measured in the mechanical transmission system, and the threshold may be a maximum torque of the mechanical transmission system.

For example, such a measured engine torque may be an input or output torque, or even an internal torque, of a power transmission gearbox of the mechanical transmission system, and the maximum engine torque is then a maximum torque.

In this way, as soon as the current position of the flight control reaches the limit position, i.e., as soon as the functional parameter relating to the mechanical transmission system is substantially equal to the threshold, the electric machine is controlled to supply a non-zero mechanical power to the rotor, via the mechanical transmission system, thus limiting, or even avoiding, the risk that this functional parameter of the mechanical transmission system exceeds the threshold, and subsequently limits the risks of degradation of the mechanical transmission system.

Alternatively, the functional parameter may be a speed of rotation of the rotor, that is equal to the speed of rotation of an output shaft of the mechanical transmission system, and the threshold may be a minimum speed of rotation of the rotor.

Indeed, the rotor may have a nominal speed of rotation to be respected, in particular in the case of a rotorcraft, to ensure safe flight. Thus, when the speed of rotation decreases and is less than this nominal speed of rotation, the electric machine is controlled to supply non-zero mechanical power to the rotor in order to maintain an acceptable speed of rotation of the rotor.

In this case, the predetermined force law may preferably be a damping law or a vibratory law, although other laws may be used.

Alternatively, the functional parameter may be a distance reachable by the aircraft and the threshold may be a target distance, for example to reach an identified landing point. This distance reachable by the aircraft is a function of the amount of fuel available to power the one or more heat engines, or even the amount of electrical energy of the source, and may be associated with a maximum mechanical power that the power plant must supply to the rotor to ensure that the aircraft travels at least this target distance. Indeed, exceeding this maximum mechanical power would lead in particular to excessive consumption of the electrical energy of the source and would prevent the aircraft from travelling this target distance.

In this case, the electric machine may supply non-zero power independently of this functional parameter, for example before the functional parameter reaches the threshold. The first force then informs the pilot that by continuing to fly at current power, the aircraft risks not reaching the landing point.

According to one possibility compatible with the preceding possibilities, the source may comprise an electric battery, and the current amount of electric energy of the source is a charge level of electric energy of the electric battery.

Alternatively or in a complementary manner, the source may comprise a fuel cell, and the current amount of electrical energy of the source is a function of an amount of fuel contained in a tank supplying the fuel cell and is, for example, proportional to this amount of fuel, or is even equal to this amount of fuel, by mass or by volume.

According to one possibility compatible with the preceding possibilities, the method may comprise applying a second force to the flight control using the control actuator, when the current position of the flight control is equal to the limit position.

This second force is thus applied to the flight control when the functional parameter of the power plant is substantially equal to the threshold, or even when the electric machine supplies non-zero mechanical power to the rotor, if applicable.

The pilot may thus be aware, using the flight control and the perception of the second force, that the functional parameter of the power plant reaches a threshold, or even that the electric machine supplies non-zero mechanical power to the rotor.

This perception may take the form of a soft stop, a hard stop or friction on the flight control generated by the second force. A soft or hard stop is characterized by a greater or lesser force to be exceeded so that the control reaches a position beyond this limit position. No force is then applied to the flight control once the limit position is exceeded. Friction is characterized by a constant force during the movement of the flight control, thus independently of the position of the flight control.

The method according to the disclosure thus makes it possible to supply a flight control having a force feedback controlled as a function of the use of the power plant of the aircraft and in particular of the one or more electric machines, in order to signal firstly, using the second force, the supply of non-zero mechanical power by the one or more electric machines and secondly, using the first force, the level of availability of these one or more electric machines.

This method thus makes it possible to give the pilot, in real time, the information as to whether or not he is using the one or more electric machines, as well as information relating to the amount of electrical energy available to power this one or more electric machines.

Furthermore, the second force can be integrated into the predetermined force law, this force law thus defining the first and second forces. Alternatively, the second force may be defined and generated independently of the first force and the force law.

Another object of the present disclosure is a piloting assistance device for an aircraft, the piloting assistance device comprising at least one drive train for controlling an aerodynamic control surface, the drive train being provided with a flight control and a control actuator connected to the flight control, the piloting assistance device comprising a computer connected to the control actuator, the aircraft comprising a hybrid power plant, the hybrid power plant being provided with at least one heat engine, at least one electric machine, a source of electrical energy and a mechanical transmission system driving the rotation of a rotor.

This piloting assistance device is remarkable in that the computer is configured to implement the piloting assistance method described above.

For this purpose, the piloting assistance device may comprise, in particular, a measurement sensor measuring at least one characteristic of the aircraft, an angular sensor measuring the current position of the flight control and a memory storing the predetermined force law.

Finally, one object of the disclosure is an aircraft comprising at least one drive train for controlling an aerodynamic control surface, the drive train being provided with a flight control and with a control actuator connected to the flight control, the aircraft comprising a hybrid power plant, said hybrid power plant being provided with at least one heat engine, at least one electric machine, a source of electrical energy and a mechanical transmission system driving the rotation of a rotor.

This aircraft comprises a piloting assistance device as described above.

### BRIEF DESCRIPTION OF THE DRAWINGS

The disclosure and its advantages appear in greater detail from the following description of examples given by way of illustration with reference to the accompanying figures, wherein:

FIG. 1 is a view of a mechanical flight control system of an aircraft;

FIG. 2 is a view of an electrical flight control system of an aircraft;

FIG. 3 is a view of an aircraft comprising a flight control system according to FIG. 1 or 2;

FIG. 4 is a block diagram of a method according to the disclosure;

FIG. 5 is a graph showing a stepwise force law;

FIG. 6, is a graph showing a law of elastic force;

FIG. 7, is graph showing a damping force law;

FIG. 8, is a graph showing an example of variation in stiffness associated with a force law; and

FIG. 9 is a graph showing an example of variation in stiffness associated with a force law.

### DETAILED DESCRIPTION

Elements present in more than one of the figures are given the same reference signs in each of them.

FIG. 1 shows a mechanical flight control system 3 for an aircraft 1.

Such a mechanical flight control system 3 has the function of controlling movements of one or more aerodynamic control surfaces 20 making it possible to steer the aircraft 1. Such aerodynamic control surfaces 20 may comprise blades of a rotor 25, in particular a lift rotor or of a rotor for controlling the yaw movement, or even of propellers, as well as ailerons or rudder flaps.

Independently of the nature of the aerodynamic control surfaces 20, the mechanical flight control system 3 comprises at least one drive train 35 and at least one flight actuator 28 connected to an aerodynamic control surface 20. For example, a flight actuator 28 may be in the form of a servo controller capable of controlling the pitch of one or more blades.

Such a mechanical flight control system 3 may comprise a single flight actuator 28 or a plurality of flight actuators 28. In addition, a flight actuator 28 may be associated with a single mechanical flight control system 3 or be shared by multiple mechanical flight control systems 3. For example, flight actuators 28 controlling the pitch of blades of a rotor 25 may be controlled by a collective pitch lever and a cyclic control stick.

The drive train 35 is provided with a flight control 31 and optionally with at least one connecting rod, or even, according to the example, with a plurality of connecting rods 32, 33, 34, 36, 37, 38 that are articulated to one another, or even with at least one connection such as a bell crank 39, or even with a combiner. The drive train 35 also comprises one or more control actuators 30. Reference sign "30" designates any of the control actuators of a drive train 35, references "301, 302" designating specific control actuators if necessary.

According to the example of FIG. 1, a drive chain 35 may comprise a parallel actuator 301 and a series actuator 302.

According to the example shown, the parallel or trim actuator 301 connects a connecting rod 33 of the drive train 35, via a connecting rod 303, to a fixed point of a structure 5 of the aircraft 1. This parallel actuator 301 may comprise, for example, a cylinder or an electric motor. This parallel actuator 301 can thus act on the flight control 31 to anchor this flight control 31 at a determined position and/or apply a force to this flight control 31.

According to the example shown, the series actuator 302 connects together two connecting rods 34, 36 of the drive train 35. The series actuator 302 may comprise, for example, an electrical, pneumatic or hydraulic actuator. This series actuator 302 can thus control the flight actuator 28 via the connecting rods 36, 37, 38, in a manner that is transparent for a pilot, i.e., without modifying the position of the flight control 31, the latter being anchored by virtue of the parallel actuator 301.

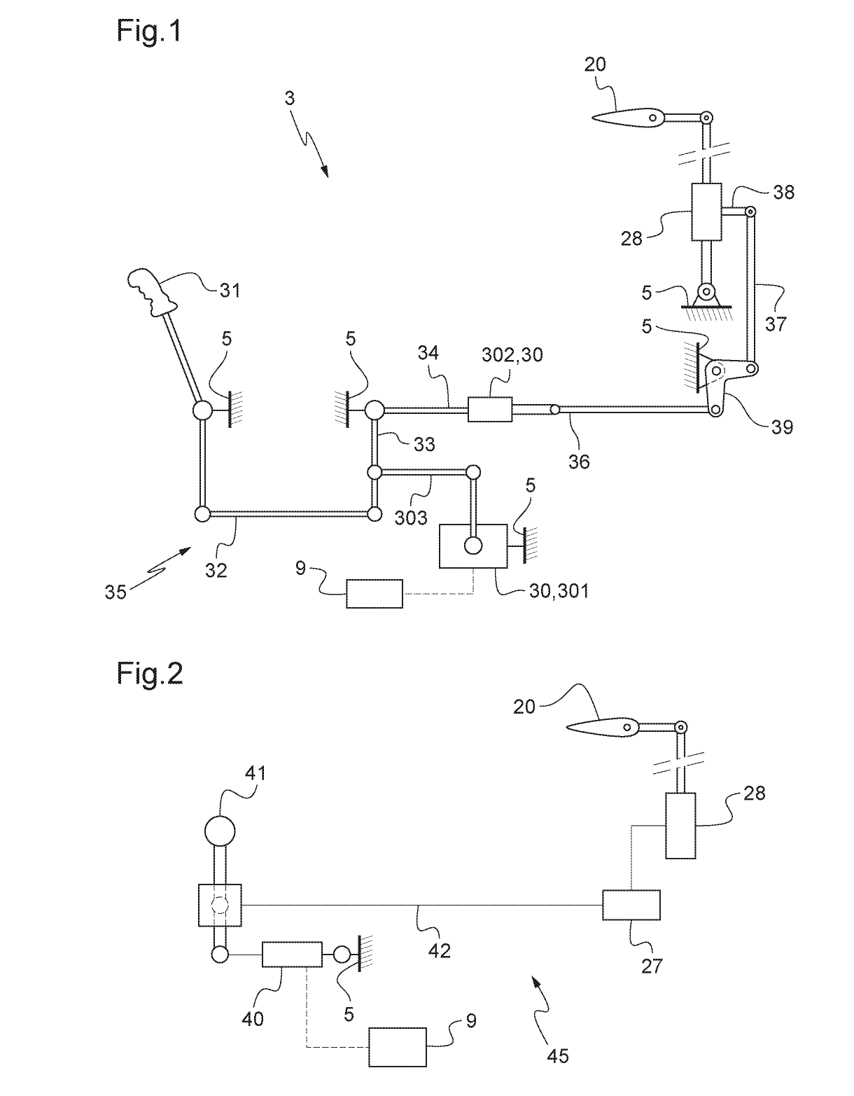

FIG. 2 shows an electrical flight control system 4 for an aircraft 1. As with a mechanical flight control system 3, an electrical flight control system 4 may comprise a single flight actuator 28 or a plurality of flight actuators 28, this or these flight actuators 28 may be associated with a single electrical flight control system 4 or be shared by a plurality of electrical flight control systems 4.

This electrical flight control system 4 comprises a drive train 45 and the flight actuator 28 connected to an aerodynamic control surface 20. The drive train 45 is provided with a flight control 41, for example of the mini-stick or joystick type, and with at least one electrical connection 42 connecting the flight control 41 to the flight actuator 28 via at least one computer 27. The drive train 45 may also comprise one or more control actuators 40 connecting, according to the example shown, the flight control 41 to a fixed point of a structure 5 of the aircraft 1. This flight actuator 40 may comprise, for example, a cylinder or an electric motor. This control actuator 40 can thus act on the flight control 41 to anchor this flight control 41 at a determined position and/or apply a force to this flight control 41. The flight control 41 may thus transmit, using the electrical link 42, a digital or analog, electrical or optical signal to the computer 27 controlling the flight actuator 28.

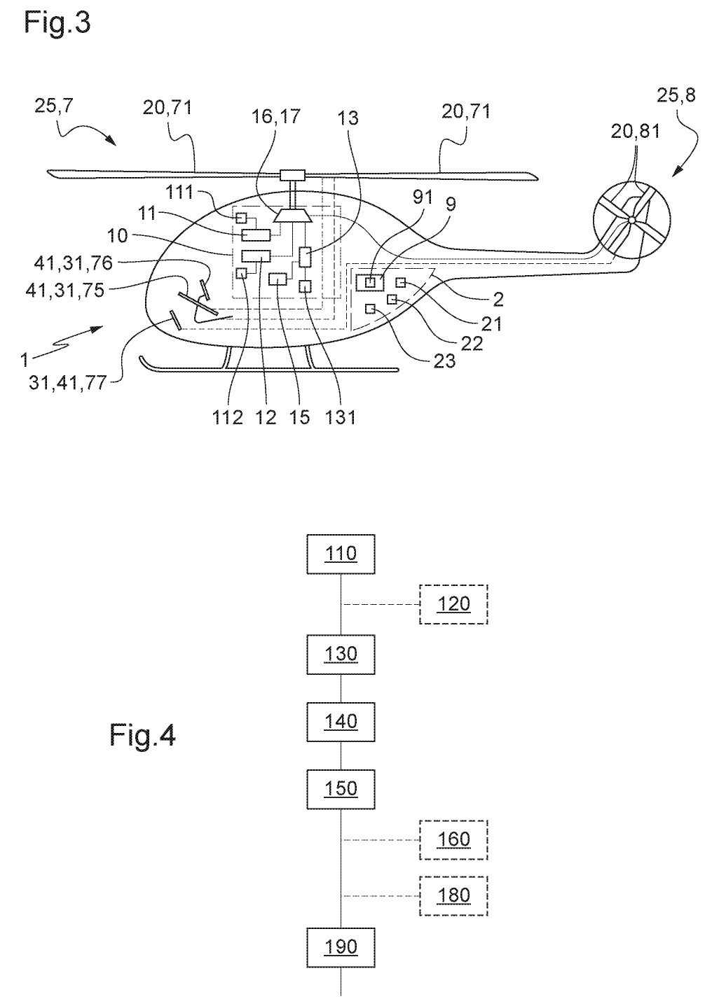

According to the example of FIG. 3, the aircraft 1 may be a helicopter comprising a main rotor 7 and a yaw movement control rotor 8. In this case, the aircraft 1 may comprise a plurality of mechanical 3 or electrical 4 flight control systems respectively provided with a plurality of flight controls 31, 41 and, for example, a collective pitch lever 75 controlling a collective variation in the pitch of the first blades 71 of the main rotor 7, a cyclic pitch stick 76 controlling a cyclic variation in the pitch of these first blades 71, and a rudder bar 77 controlling a collective variation in the pitch of the second blades 81 of the yaw movement control rotor 8.

The aircraft 1 also comprises a hybrid power plant 10 equipped with one or more heat engines 11, 12, one or more electric machines 13, a source 15 of electrical energy and a mechanical transmission system 16 driving the rotation of one or more rotors 25. According to the exemplary aircraft 1 shown in FIG. 3, the mechanical transmission system 16 can rotate the main 7 and yaw movement control 8 rotors.

The source 15 is electrically connected to the one or more electric machines 13, that may be an electric motor, an electrical generator or a motor-generator. The source 15 may comprise one or more, optionally rechargeable, electric batteries. Alternatively or in a complementary manner, the source 15 may comprise one or more fuel cells, for example hydrogen or methanol fuel cells, as well as a tank containing this fuel and connected to the one or more fuel cells.

According to the example illustrated, the mechanical transmission system 16 comprises a power transmission gearbox 17 and the hybrid power plant 10 comprises two heat engines 11, 12 and an electric machine 13. The two heat engines 11, 12 and the electric machine 13 are respectively connected to input shafts of the power transmission gearbox 17, output shafts of the power transmission gearbox 17 being connected mechanically and respectively to the rotors 7, 8 that can thus be driven in rotation jointly or independently by the two heat engines 11, 12 and the electric machine 13. The heat engines 11, 12 are connected respectively to engine computers 111, 121, for example FADEC (Full Authority Digital Engine Control) system computers, controlling the operation of these heat engines 11, 12. The electric machine 13 is connected to a motor controller 131 controlling the operation of this electric machine 13.

Alternatively, the electric machine 13 may be interposed between a heat engine 11 and the mechanical transmission system 16, for example between this heat engine 11 and an input shaft of the power transmission gearbox 17 of this mechanical transmission system 16. In this case, the electric machine 13 and the heat engine 11 can jointly drive the rotation of this input shaft of the power transmission gearbox 17.

Alternatively, the hybrid power plant 10 may comprise one or more heat engines 11, 12 driving the rotation of one or more electrical generators 13 in order to transform mechanical energy into electrical energy in order to supply the source 15, or even other electrical machines 13. The hybrid power plant 10 also comprises one or more electric motors 13 driving the rotation of one or more rotors 25 via the mechanical transmission system 16.

The aircraft 1 may also comprise a device 2 for assisting the piloting of the aircraft 1. Irrespective of whether the aircraft 1 comprises one or more mechanical 3 or electrical 4 flight control systems, this piloting assistance device 2 is provided with a computer 9 connected to the control actuator or actuators 30, 40 of the drive train 31, 41. The computer 9 can be dedicated to the piloting assistance device 2, or optionally shared with other equipment of the aircraft 1.

The piloting assistance device 2 may comprise a plurality of sensors measuring various characteristics or parameters of the aircraft 1 and connected to the computer 9 via a wired or wireless link. For example, the piloting assistance device 2 may comprise an angular sensor 21 measuring a current position of the flight control 31, 41. This current position is, for example, measured relative to a reference position of the flight control 31, 41 that may be a neutral position of the flight control 31, 41 when no force is applied thereto by a pilot.

The piloting assistance device 2 may comprise a thermometer 22 measuring the outside temperature as well as a barometer 23 measuring the atmospheric pressure outside the aircraft 1.

The piloting assistance device 2 may comprise other sensors for measuring characteristics of the power plant 10. For example, the piloting assistance device 2 may comprise a torque meter for measuring an engine torque within the mechanical transmission system 16, or even a thermometer and a chronometer for respectively measuring an internal temperature and an aging rate of the mechanical transmission system 16. The piloting assistance device 2 may also comprise one or more tachometers for measuring a speed of rotation of an input or output shaft of the mechanical transmission system 16. The piloting assistance device 2 may also comprise a torque meter, a tachometer and a chronometer for measuring an engine torque, a speed of rotation on an input or output shaft of the power transmission gearbox 17, as well as an ageing rate of the power transmission gearbox 17.

One characteristic of the power plant 10 may also be the speed of rotation of the rotor 25, that is equal to a speed of rotation of an output shaft of the mechanical transmission system 16, and in particular of an output shaft of the power transmission gearbox 17, measured using a tachometer.

The computer 9 may also be connected, via a wired or wireless link, to the engine computers 111, 121 in order to receive information relating to characteristics of the heat engines 11, 12. These characteristics of the heat engines 11, 12 may be, for example, an internal temperature of the heat engine 11, 12, an engine torque, a duration of use of this engine torque, a total duration of use and/or an ageing rate.

The engine computers 111, 121 and the sensors then respectively transmit digital or analog, electrical or optical signals to the computer 9, via the wired or wireless links, these signals carrying values of this or these characteristics.

In addition, the computer 9 may comprise a memory or be connected to such a memory. This memory may store one or more segments of codes or a computer program implemented by the computer 9 in order to carry out the steps of a method for assisting the piloting of the aircraft 1. FIG. 4 shows a block diagram of this piloting assistance method. This method may comprise the following steps.

Firstly, the method comprises measuring 110 one or more characteristics of the one or more heat engines 11, 12, of the mechanical transmission system 16 or of the rotor 25. This measurement 110 of one or more characteristics may be carried out using an engine computer 111, 121 associated with one of the heat engines 11, 12 and/or sensors positioned on the one or more heat engines 11, 12, the mechanical transmission system 16 or the rotor 25.

This method may also optionally comprise measuring 120 one or more environmental parameters. These environmental parameters comprise, for example, a temperature and an atmospheric pressure outside the aircraft 1, measured using the thermometer 22 and barometer 23.

Next, the method comprises determining 130 a threshold relating to a functional parameter of the hybrid power plant 10, using the computer 9, as a function of the one or more previously measured characteristics. This threshold may optionally also be determined as a function of one or more environmental parameters. This threshold may be determined using one or more laws or tables previously recorded in a memory of the computer 9 or in a memory connected to the computer 9, and involving the one or more characteristics of the one or more heat engines 11, 12, of the mechanical transmission system 16 and/or of the rotor 25, or even, where appropriate, one or more environmental parameters.

The functional parameter may be the engine torque of one of the heat engines 11, 12 transmitted by the engine computer 111, 121 associated with this heat engine 11, 12 or measured by a sensor positioned on this heat engine 11, 12, the threshold then being a predetermined limit torque for this heat engine 11, 12.

Alternatively, the functional parameter may be an engine torque measured by a suitable sensor positioned in the mechanical transmission system 16, the threshold then being a maximum torque of the mechanical transmission system 16. The functional parameter may in particular be an engine torque measured by a torque meter positioned on an input or output shaft of the power transmission gearbox 17.

Alternatively, the functional parameter may be the speed of rotation of the rotor 25 measured by a tachometer, the threshold then being a minimum speed of rotation of the rotor 25.

Alternatively, the functional parameter may be a distance reachable by the aircraft 1 determined by a dedicated computer or avionics system of the aircraft 1 and the threshold then being a target distance.

The method then comprises calculating 140 a limit position of the flight control 31, 41 for which the functional parameter of the hybrid power plant 10 is equal to the threshold. This calculation 140 is carried out by the computer 9 as a function of the threshold, the functional parameter of the hybrid power plant 10, or even a forward speed of the aircraft 1 and a speed of rotation of the rotor 25. This calculation 140 may be carried out using one or more laws or tables previously recorded in a memory of the computer 9 or in a memory connected to the computer 9.

The method then comprises measuring 150 a current position of the flight control 31, 41, for example using the angular sensor 21. This current position of the flight control 31, 41, as well as the limit position of the flight control 31, 41, may be defined respectively by angles of the flight control 31, 41 relative to the reference position of the flight control 31, 41.

Finally, the method comprises applying 190 a first force to the flight control 31, 41 using the control actuator 30, 40 according to a predetermined force law when the current position of the flight control 31, 41 exceeds the limit position, the predetermined force law being a function at least of a current amount of electrical energy of the source 15. In the context of the example of a mechanical flight control system 3 shown in FIG. 1, the first force may be applied preferentially by the parallel actuator 301, although the series actuator 302 may also apply this first force alone, or even jointly with the parallel actuator 301.

For this purpose, the computer 9 transmits a digital or analog, electrical or optical signal via a wired or wireless link, to the control actuator 30, 40, this signal carrying information relating to the first force. The control actuator 30, 40 can then generate the first resistive force on the flight control 31, 41 by applying the predetermined force law as soon as the limit position is exceeded by the current position of the flight control 31, 41.

In order to generate this resistive force, the control actuator 30, 40, when it is a pneumatic or hydraulic cylinder, adapts the pressure of the fluid in the chambers of this cylinder as a function of the predetermined force law and the movement of the flight control 31, 41. When the control actuator 30, 40 is an electric motor, the torque applied by the control actuator 30, 40, directly or indirectly to the flight control 31, 41, is adapted as a function of the predetermined force law and the movement of the flight control 31, 41, as described, for example, in document FR 2946620.

The current amount of electrical energy of the source 15 is, for example, an electrical energy charge level of the battery when the source 15 comprises a battery. When the source 15 comprises a fuel cell, the current amount of electrical energy can then be a function of an amount of fuel contained in a tank supplying the fuel cell, or even equal to this amount of fuel.

The pilot of the aircraft 1 then feels this first force when he acts on the flight control 31, 41 and can become aware of the current amount of electrical energy of the source 15. He can then pilot the aircraft 1 by feeling a haptic feedback image of the amount of energy available for the one or more electric machines 13 of the hybrid power plant 10.

One or more predetermined force laws may be recorded in a memory of the computer 9 or in a memory connected to the computer 9.

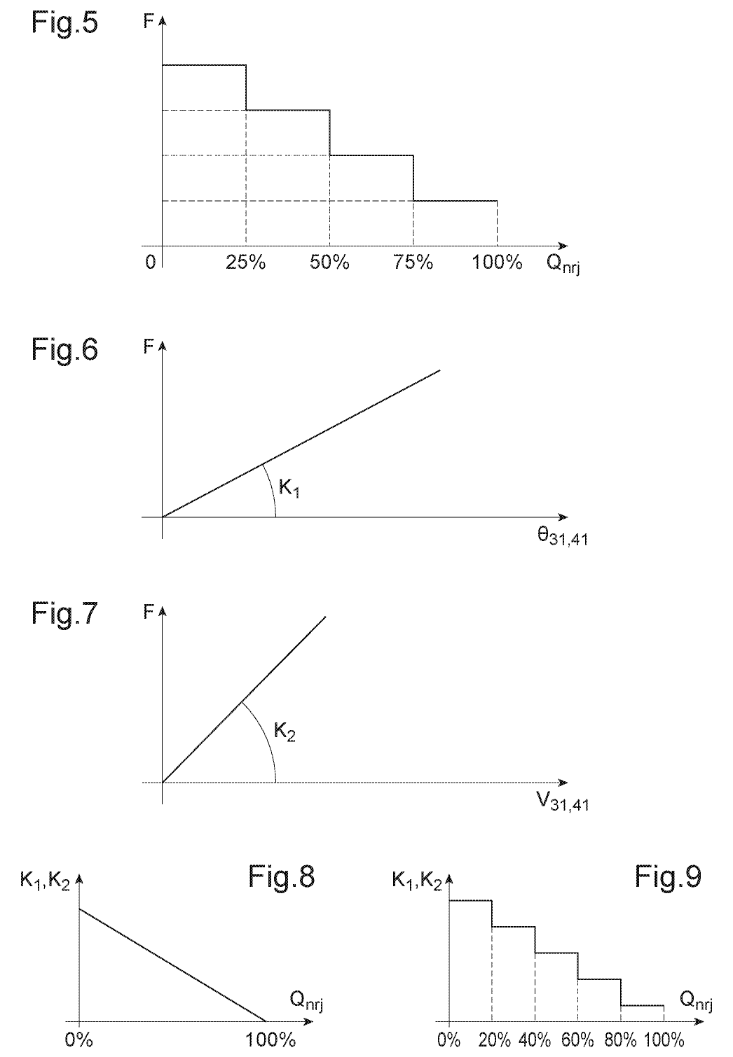

Such a predetermined force law may be a stepwise law. Such a stepwise law, an example of which is shown in FIG. 5, comprises steps respectively associated with intervals of the amount Q nrj of electrical energy of the source 15. The first force F is thus constant for each step and increases from one step to the next when the amount Q nrj of electrical energy of the source 15 decreases.

Such a predetermined force law may also be an elastic law. For such an elastic law, an example of which is shown in FIG. 6, the first force F varies with the current position 31, 41 of the flight control 31, 41. The first force F is for example equal to the product of the current angle 31, 41 of the flight control 31, 41 and a first stiffness K 1 that increases when the amount Q nrj of electrical energy of the source 15 decreases. The first stiffness may continuously increase as this amount Q nrj of electrical energy decreases, as shown in FIG. 8. Alternatively, the first stiffness may increase in steps, when this amount Q nrj of electrical energy decreases, as shown in FIG. 9.

Such a predetermined force law may alternatively be a damping law. According to such a damping law, an example of which is shown in FIG. 7, the first force F varies with the speed V 31,41 of movement of the flight control 31,41. For example, the first force F is equal to the product of this speed V 31, 41 of movement and a second stiffness K 2, that increases when the amount Q nrj of electrical energy of the source 15 decreases. The second stiffness K 2 can increase continuously when this amount Q nrj of electrical energy of the source 15 decreases, as shown in FIG. 8. Alternatively, the second stiffness K 2 may increase in steps, when this amount Q nrj of electrical energy of the source 15 decreases, as shown in FIG. 9.

Such a predetermined force law may also be a vibratory law. According to such a vibratory law, the first force generates vibrations in the flight control 31, 41 each time predetermined levels of the amount of electrical energy of the source 15 are passed. These predetermined levels correspond for example to percentages of a maximum capacity of the electrical energy source 15, for example 25%, 50% and 75%. The intensity of these vibrations may be the same for each passing. Alternatively, the intensity of these vibrations may increase from one passing to the next, when the amount of electrical energy of the source 15 decreases.

When several predetermined force laws are recorded in the memory, the computer 9 can automatically choose the law used according to a flight phase, for example. In particular, the avionics system of the aircraft 1 can conventionally supply a signal carrying information relating to this flight phase to the computer 9. Alternatively, before take-off or during flight, the pilot may choose the law used, using a human-machine interface, for example a screen provided with a touch panel, connected to the computer 9.

In addition, the method of the disclosure may comprise supplying 160 by the electric machine 13 non-zero mechanical power to the rotor 25 when the current position of the flight control 31, 41 is greater than or equal to the limit position. The computer 9 then transmits a digital or analog, electrical or optical signal, via a wired or wireless link, to the electric machine 13, or to the motor controller 131 associated with the electric machine 13, this signal carrying information relating to the mechanical power that this electric machine 13 must supply.

Indeed, when the current position of the flight control 31, 41 reaches or even exceeds the limit position, then a functional parameter of the power plant 10 reaches or even exceeds the associated threshold.

Therefore, for example to protect the power plant 10, and to avoid degradation of a heat engine 11, 12 or of the mechanical transmission system 16, the electric machine 13 can supply non- zero mechanical power contributing to the driving of the rotation of the rotor 25. This is the case, in particular, when the functional parameter relates to the heat engines 11, 12 or to the mechanical transmission system 16.

Furthermore, when the functional parameter is the speed of rotation of the rotor 25 and this parameter decreases until it reaches the associated threshold, the electric machine 13 can then supply non-zero mechanical power contributing to the driving of the rotation of the rotor 25 so as to limit the decrease in this speed of rotation, or even to increase it.

In addition, the method according to the disclosure may comprise applying 180 a second force to the flight control 31, 41 using the control actuator 30, 40 when the current position of the flight control 31, 41 is equal to the limit position. Thus, the pilot knows that the functional parameter has reached the associated threshold, or that the electric machine 13 begins to supply non-zero mechanical power contributing to the driving in rotation of the rotor 25. This second force may take the form of a soft stop, a hard stop or friction, or even vibrations.

For this purpose, the computer 9 transmits a digital or analog, electrical or optical signal via a wired or wireless link, to the control actuator 30, 40, this signal carrying information relating to the second force. The control actuator 30, 40 may then generate the second resistive force on the flight control 31, 41 as soon as the current position of the flight control 31, 41 reaches the limit position.

Naturally, the present disclosure may be subjected to numerous variations as to its implementation. Although several embodiments are described above, it should readily be understood that it is not conceivable to identify exhaustively all the possible embodiments. It is naturally possible to replace any of the means described with equivalent means without going beyond the ambit of the present disclosure.

What is claimed is:

1. A method for assisting the piloting of an aircraft, the aircraft comprising at least one drive train for controlling an aerodynamic control surface, the drive train being provided with a flight control and with a control actuator connected to the flight control, the aircraft comprising a hybrid power plant, the hybrid power plant being provided with at least one heat engine, at least one electric machine, a source of electrical energy and a mechanical transmission system driving a rotation of a rotor,
wherein the method comprises the following steps:
measuring at least one characteristic of the at least one heat engine, of the mechanical transmission system or of the rotor;
determining a threshold relating to a functional parameter of the hybrid power plant as a function of the at least one characteristic;
calculating a limit position of the flight control for which the functional parameter of the hybrid power plant is equal to the threshold;
measuring a current position of the flight control; and
applying a first force to the flight control using the control actuator according to a predetermined force law when the current position of the flight control exceeds the limit position, the predetermined force law being a function at least of a current amount of electrical energy of the source.

2. The method according to claim 1,
comprising supplying by the electric machine non-zero mechanical power to the rotor when the current position of the flight control is greater than or equal to the limit position.

3. The method according to claim 1,
wherein the current position and the limit position of the flight control are respectively defined by angles of the flight control with respect to a reference position of the flight control.

4. The method according to claim 1,
comprising applying a second force to the flight control using the control actuator when the current position of the flight control is equal to the limit position.

5. The method according to claim 1,
wherein the at least one characteristic comprises one or more of the following characteristics:
an internal temperature, an engine torque, a maximum engine torque and an aging rate of the at least one heat engine;
an internal temperature, an engine torque, a maximum engine torque and an aging rate of the mechanical transmission system; and
a speed of rotation of the rotor.

6. The method according to claim 1,
comprising measuring at least one environmental parameter from a temperature and an atmospheric pressure external to the aircraft, determining the threshold and calculating the limit position of the flight control being a function of the at least one environmental parameter.

7. The method according to claim 1,
wherein the functional parameter is an engine torque of the at least one heat engine, and the threshold is a predetermined limit torque of the at least one heat engine.

8. The method according to claim 1,
wherein the functional parameter is a torque measured in the mechanical transmission system, and the threshold is a maximum torque of the mechanical transmission system.

9. The method according to claim 1,
wherein the functional parameter is a speed of rotation of the rotor, and the threshold is a minimum speed of rotation of the rotor.

10. The method according to claim 1,
wherein the functional parameter is a distance reachable by the aircraft and the threshold is a target distance.

11. The method according to claim 1,
wherein calculating the limit position of the flight control is carried out as a function of the threshold of the functional parameter of the hybrid power plant, a forward speed of the aircraft and a speed of rotation of the rotor.

12. The method according to claim 1,
wherein the predetermined force law is selected from:
a stepwise law, the steps being associated respectively with intervals of the amount of electrical energy of the source, the first force being constant for each step and increasing from one step to the next in parallel with a decrease in the amount of electrical energy of the source;
an elastic law, the first force varying with the current position of the flight control, and being equal to a current angle of the flight control multiplied by a first stiffness, the first stiffness increasing as a function of a decrease in the amount of electrical energy of the source, continuously or in steps, the current angle of the flight control being defined with respect to a reference position of the flight control;
a damping law, the first force varying with a speed of movement of the flight control, and being equal to the speed of movement multiplied by a second stiffness, the second stiffness increasing as a function of a decrease in the amount of electrical energy of the source, continuously or in steps; and
a vibratory law, the first force generating vibrations in the flight control at each passing of predetermined levels of electrical energy of the source, an intensity of the vibrations being identical at each passing, or gradually increasing from one passing to another as the amount of electrical energy of the source decreases.

13. The method according to claim 1,
wherein the source comprises an electric battery and the current amount of electrical energy is an electrical energy charge level of the electric battery, or the source comprises a fuel cell and the current amount of electrical energy is a function of an amount of fuel contained in a tank supplying the fuel cell.

14. A device for assisting the piloting of an aircraft, the piloting assistance device comprising at least one drive train for controlling an aerodynamic control surface, the drive train being provided with a flight control and with a control actuator connected to the flight control, the piloting assistance device comprising a computer connected to the control actuator, the aircraft comprising a hybrid power plant, the hybrid power plant being provided with at least one heat engine, at least one electric machine, a source of electrical energy and a mechanical transmission system driving a rotation of a rotor,
wherein the computer is configured to implement the method according to claim 1, the piloting assistance device comprising a measurement sensor measuring at least one characteristic of the aircraft, an angular sensor measuring the current position of the flight control and a memory storing the predetermined force law.

15. An aircraft comprising at least one drive train for controlling an aerodynamic control surface, the drive train being provided with a flight control system and with a control actuator connected to the flight control system, the aircraft comprising a hybrid power plant, the hybrid power plant being provided with at least one heat engine, at least one electric machine, a source of electrical energy and a mechanical transmission system driving a rotation of a rotor,
wherein the aircraft comprises the piloting assistance device according to claim 14.
